(19) United States
(12) Patent Application Publication
(10) Pub. No.: US 2016/0036637 A1
(43) Pub. Date: Feb. 4, 2016

(54) SIGNALING CHANGE IN LINK CONFIGURATION

(71) Applicant: QUALCOMM Incorporated, San Diego, CA (US)

(72) Inventors: Rahul MALIK, San Diego, CA (US); Rahul TANDRA, San Diego, CA (US); George CHERIAN, San Diego, CA (US)

(21) Appl. No.: 14/815,600

(22) Filed: Jul. 31, 2015

Related U.S. Application Data
(60) Provisional application No. 62/033,004, filed on Aug. 4, 2014.

(51) Int. Cl. H04L 12/24; H04W 28/18

(52) U.S. Cl. CPC H04L 41/0816; H04W 28/18; H04W 84/12

(57) ABSTRACT

A method, an apparatus, and a computer program product for wireless communication are provided. In one aspect, the apparatus, being a first wireless device, establishes a session with a second wireless device based on a first set of link parameters and transmits, to the second wireless device, information regarding a second set of link parameters for use by the second wireless device for subsequent communication during the session. In another aspect, the apparatus establishes a session with a second wireless device based on a first set of link parameters, receives, from the second wireless device, information regarding a second set of link parameters, and communicates with the second wireless device based on the information regarding the second set of link parameters.

### CROSS-REFERENCE TO RELATED APPLICATION(S)

This application claims the benefit of U.S. Provisional Application Ser. No. 62/033,004, entitled “Signaling Change in Link Configuration” and filed on Aug. 4, 2014, which is expressly incorporated by reference herein in its entirety.

### BACKGROUND

1. Field

The present disclosure relates generally to communication systems, and more particularly, to a first wireless device (e.g., a station or an access point) dynamically informing a second wireless device (e.g., an access point or a station) of a modified link configuration during a communication session with the second wireless device.

2. Background

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, Synchronous Optical Networking (SONET), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc., frequency bands. Wireless networks advantageously facilitate user mobility and rapid field deployment when compared to fixed wired networks.

### SUMMARY

The systems, methods, computer program products, and devices of the invention each have several aspects, no single one of which is solely responsible for the invention's desirable attributes. Without limiting the scope of this invention as expressed by the claims which follow, some features will now be discussed briefly. After considering this discussion, and particularly after reading the section entitled “Detailed Description” one will understand how the features of this invention provide advantages that include improved narrowband channel selection for devices in a wireless network.

One aspect of the disclosure provides an apparatus for wireless communication. The apparatus is configured to establish a session with a wireless device based on a first set of link parameters. The apparatus is configured to transmit, to the wireless device, information regarding a second set of link parameters for use by the wireless device for subsequent communication during the session.

Another aspect of the disclosure provides an apparatus for wireless communication. The apparatus includes means for establishing a session with a wireless device based on a first set of link parameters. The apparatus includes means for transmitting, to the wireless device, information regarding a second set of link parameters for use by the wireless device for subsequent communication during the session. The apparatus may include means for determining the second set of link parameters for use by the wireless device for subsequent communication. The second set of link parameters may include at least one of an antenna configuration, a number of supported receive chains, a maximum channel bandwidth supported, a preferred channel bandwidth supported, a preferred band of operation, an available band of operation, a maximum number of spatial streams supported, a highest supported data rate/modulation and coding scheme (MCS), a maximum aggregated medium access control (MAC) protocol data unit (MPDU) (AMPDU) length, or a time at which the second set of link parameters is enabled. In an aspect, the established session may be a WLAN association. In another aspect, the apparatus may include means for establishing a second session with a second wireless device. The second session may be a WAN association, and the session may be a WLAN association. In another aspect, the session and the second session may share available antenna resources or available front-end components. In another aspect, the apparatus may include means for determining a change in link conditions associated with the second session. The second set of link parameters may be determined based on the change in the link conditions associated with the second session. The means for determining a change in the link conditions may be configured to perform one or more of detecting that the second session requires a change in diversity (e.g., transmit diversity or receive diversity), detecting that a throughput requirement associated with the second session has changed, or detecting that the second session has terminated. In another aspect, the wireless device is an access point or a station. In another aspect, the apparatus may include means for receiving a signal from the wireless device during the session, and the signal may be received according to a transmission mode based on the second set of link parameters. In another aspect, the information may be transmitted via at least one of a management frame, an information element of the management frame, a control field of a data frame or of a null frame, a control frame, a data frame, an MPDU within an AMPDU, or a MAC service data unit (MSDU) within an aggregated MSDU (AMSDU). In another aspect, the information may include at least one of an antenna configuration, a number of supported receive chains, a maximum channel bandwidth supported, a preferred channel bandwidth supported, a preferred band of operation, an available band of operation, a maximum number of spatial streams supported, a highest supported data rate/MCS, a maximum AMPDU length, or a time at which the second set of link parameters is enabled. In another aspect, the information is transmitted at a higher MCS than an association frame or a re-association frame. In another aspect, the information is transmitted to the wireless device in a packet of a higher priority than other packets transmitted to the wireless device.

Another aspect of the disclosure provides a computer-readable medium storing computer executable code for wireless communication. The computer-readable medium may be associated with a first wireless device. The computer-readable medium may include code for establishing a session with a second wireless device based on a first set of link parameters and for transmitting, to the second wireless device, information regarding a second set of link parameters for use by the second wireless device for subsequent communication during the session. The computer-readable medium may further include code for determining the second set of link parameters for use by the second wireless device for subsequent communication. In an aspect, the second set of link parameters may include at least one of an antenna configuration, a number of supported receive chains, a maximum channel bandwidth supported, a preferred channel bandwidth supported, a preferred band of operation, an available band of operation, a maximum number of spatial streams supported, a highest supported data rate/MCS, a maximum AMPDU length, or a time at which the second set of link parameters is enabled. In aspect, the established session may be a WLAN association. In another aspect, a second session may be established with a third wireless device. The second session may be a WAN association, and the session may be a WLAN association. In another aspect, the session and the second session may share available antenna resources or available front-end components. In another aspect, the computer-readable medium may include code for determining a change in link conditions associated with the second session. The second set of link parameters may be determined based on the change in the link conditions associated with the second session. The code for determining a change in the link conditions may include code for performing one or more of detecting that the second session requires a change in diversity, detecting that a throughput requirement associated with the second session has changed, or detecting that the second session has terminated. In another aspect, the second wireless device is an access point or a station. In another aspect, the computer-readable medium may include code for receiving a signal from the second wireless device during the session, and the signal may be received according to a transmission mode based on the second set of link parameters. In another aspect, the information may be transmitted via at least one of a management frame, an information element of the management frame, a control field of a data frame or of a null frame, a control frame, a data frame, an MPDU within an AMPDU, or an MSDU within an AMSDU. In another aspect, the information may include at least one of an antenna configuration, a number of supported receive chains, a maximum channel bandwidth supported, a preferred channel bandwidth supported, a preferred band of operation, an available band of operation, a maximum number of spatial streams supported, a highest supported data rate/MCS, a maximum AMPDU length, or a time at which the second set of link parameters is enabled. In another aspect, the information may be transmitted at a higher MCS than an association frame or a re-association frame. In another aspect, the information may be transmitted to the second wireless device in a packet of a higher priority than other packets transmitted to the second wireless device.

Another aspect of the disclosure provides an apparatus for wireless communication. The apparatus is configured to establish a session with a wireless device based on a first set of link parameters. The apparatus is configured to receive, from the wireless device, information regarding a second set of link parameters. The apparatus is configured to communicate with the wireless device based on the received information regarding the second set of link parameters.

Another aspect of the disclosure provides an apparatus for wireless communication. The apparatus includes means for establishing a session with a wireless device based on a first set of link parameters. The apparatus includes means for receiving, from the wireless device, information regarding a second set of link parameters. The apparatus includes means for communicating with the wireless device based on the received information regarding the second set of link parameters. In an aspect, the established session may be a WLAN association. In another aspect, the means for communicating with the wireless device may be configured to generate a signal for the wireless device and to transmit the signal to the wireless device during the session, in which the signal is transmitted according to a transmission mode based on the information regarding the second set of link parameters. In another aspect, the information may be received via at least one of a management frame, an information element of the management frame, a control field of a data frame or a null frame, a control frame, a data frame, an MPDU within an AMPDU, or an MSDU within an AMSDU. In another aspect, the information may include at least one of an antenna configuration at the wireless device, a number of supported receive chains at the wireless device, a maximum channel bandwidth supported at the wireless device, a preferred channel bandwidth supported at the wireless device, a preferred band of operation at the wireless device, an available band of operation at the wireless device, a maximum number of spatial streams supported at the wireless device, a highest supported data rate/MCS at the wireless device, or a maximum AMPDU length. In another aspect, the information may include a time at which the second set of link parameters is enabled. In another aspect, the information may be received from the wireless device in a packet of a higher priority than other packets received from the wireless device.

Another aspect of the disclosure provides a computer-readable medium storing computer executable code for wireless communication. The computer-readable medium may be associated with a first wireless device. The computer-readable medium may include code for establishing a session with a second wireless device based on a first set of link parameters. The computer-readable medium may include code for receiving, from the second wireless device, information regarding a second set of link parameters, and for communicating with the second wireless device based on the received information regarding the second set of link parameters. In an aspect, the established the session may be a WLAN association. In another aspect, the code for communicating with the second wireless device may include code for generating a signal for the second wireless device and code for transmitting the signal to the second wireless device during the session, in which the signal is transmitted according to a transmission mode based on the information regarding the second set of link parameters. In another aspect, the information may be received via at least one of a management frame, an information element of the management frame, a control field of a data frame or a null frame, a control frame, a data frame, an MPDU within an AMPDU, or an MSDU within an AMSDU. In another aspect, the information may include at least one of an antenna configuration at the second wireless device, a number of supported receive chains at the second wireless device, a maximum channel bandwidth supported at the second wireless device, a preferred channel bandwidth supported at the second wireless device, a preferred band of operation at the second wireless device, an available band of operation at the second wireless device, a maximum number of spatial streams supported at the second wireless device, a highest supported data rate/MCS at the second wireless device, or a maximum AMPDU length. In another aspect, the information may include a time at which the second set of link parameters is enabled. In yet another aspect, the information may be received from the second wireless device in a packet of a higher priority than other packets received from the second wireless device.

### BRIEF DESCRIPTION OF THE DRAWINGS

FIG. 1 shows an example wireless communication system in which aspects of the present disclosure may be employed.

FIG. 2 shows a functional block diagram of an example wireless device that may be employed within the wireless communication system of FIG. 1.

FIG. 3 is a diagram illustrating an example of a signal structure for transmitting information indicating a new/modified link configuration of a wireless device.

FIG. 4 is a diagram of an exemplary method for signaling a change in link configuration.

FIG. 5 is a flowchart of an example method of signaling a change in link configuration for wireless communication.

FIG. 6 is a flowchart of an example method receiving an indication of a change in link configuration for wireless communication.

FIG. 7 is a functional block diagram of an example wireless communication device capable of signaling or receiving a change in link configuration.

### DETAILED DESCRIPTION

Various aspects of the novel systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, computer program products, apparatuses, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Popular wireless network technologies may include various types of WLANs. A WLAN may be used to interconnect nearby devices together, employing widely used networking protocols. The various aspects described herein may apply to any communication standard, such as a wireless protocol.

In some aspects, wireless signals may be transmitted according to an 802.11 protocol using orthogonal frequency-division multiplexing (OFDM), direct-sequence spread spectrum (DSSS) communications, a combination of OFDM and DSSS communications, or other schemes. Implementations of the 802.11 protocol may be used for sensors, metering, and smart grid networks. Advantageously, aspects of certain devices implementing the 802.11 protocol may consume less power than devices implementing other wireless protocols, and/or may be used to transmit wireless signals across a relatively long range, for example about one kilometer or longer.

In some implementations, a WLAN includes various devices which are the components that access the wireless network. For example, there may be two types of devices: access points (APs) and clients (also referred to as stations, or STAs). In general, an AP may serve as a hub or base station for the WLAN and a STA may serve as a user of the WLAN. For example, a STA may be a laptop computer, a personal digital assistant (PDA), a mobile phone, etc. In an example, a STA connects to an AP via a Wi-Fi (e.g., IEEE 802.11 protocol) compliant wireless link to obtain general connectivity to the Internet or to other wide area networks. In some implementations a STA may also be used as an AP.

An access point may also comprise, be implemented as, or known as a NodeB, Radio Network Controller (RNC), eNodeB, Base Station Controller (BSC), Base Transceiver Station (BTS), Base Station (BS), Transceiver Function (TF), Radio Router, Radio Transceiver, connection point, or some other terminology.

A STA may also comprise, be implemented as, or known as an access terminal (AT), a subscriber station, a subscriber unit, a mobile station, a remote station, a remote terminal, a user terminal, a user agent, a user device, user equipment, or some other terminology. In some implementations a STA may comprise a cellular telephone, a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

The term “associate,” or “association,” or any variant thereof should be given the broadest meaning possible within the context of the present disclosure. By way of example, when a first apparatus associates with a second apparatus, it should be understood that the two apparatuses may be directly associated or intermediate apparatuses may be present. For purposes of brevity, the process for establishing an association between two apparatuses will be described using a handshake protocol that requires an “association request” by one of the apparatus followed by an “association response” by the other apparatus. It will be understood by those skilled in the art that the handshake protocol may require other signaling, such as by way of example, signaling to provide authentication.

Any reference to an element herein using a designation such as “first,” “second,” and so forth does not generally limit the quantity or order of those elements. Rather, these designations are used herein as a convenient method of distinguishing between two or more elements or instances of an element. Thus, a reference to first and second elements does not mean that only two elements can be employed, or that the first element must precede the second element. In addition, a phrase referring to “at least one of” a list of items refers to any combination of those items, including single members. As an example, “at least one of: A, B, or C” is intended to cover: A, or B, or C, or any combination thereof (e.g., A-B, A-C, B-C, and A-B-C).

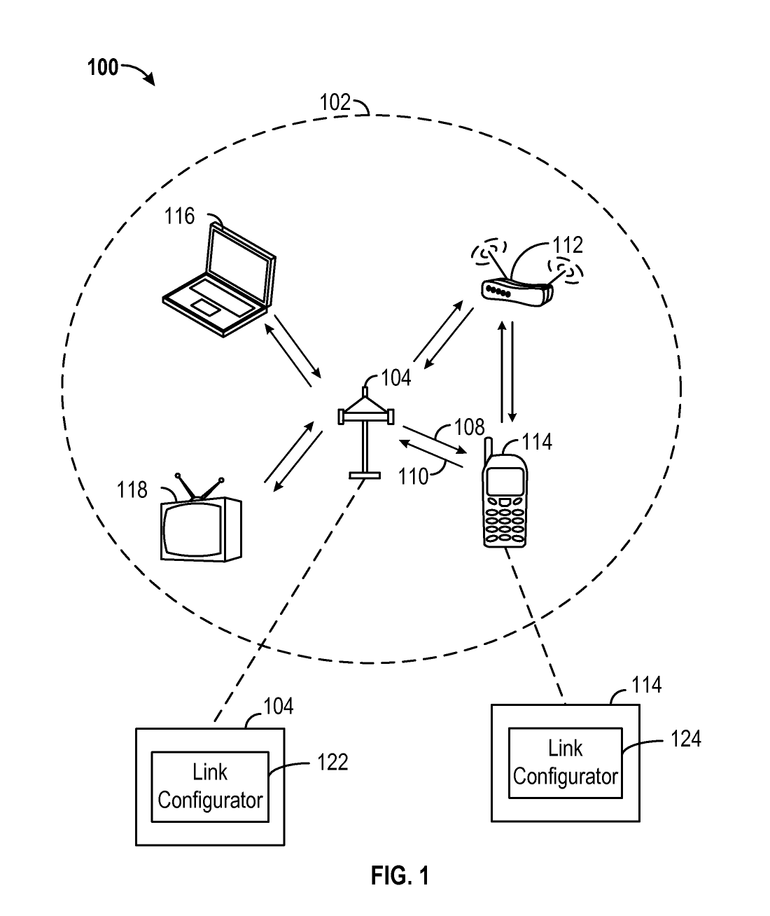

FIG. 1 shows an example wireless communication system 100 in which aspects of the present disclosure may be employed. The wireless communication system 100 may operate pursuant to one or more wireless standards, for example the 802.11 standard and/or the Long Term Evolution (LTE) standard. The wireless communication system 100 may include an AP 104, which communicates with STAs (e.g., STAs 112, 114, 116, and 118).

A variety of processes and methods may be used for transmissions in the wireless communication system 100 between the AP 104 and the STAs. For example, signals may be sent and received between the AP 104 and the STAs in accordance with OFDM/OFDMA techniques. If this is the case, the wireless communication system 100 may be referred to as an OFDM/OFDMA system. Alternatively, signals may be sent and received between the AP 104 and the STAs in accordance with CDMA techniques. If this is the case, the wireless communication system 100 may be referred to as a CDMA system.

A communication link that facilitates transmission from the AP 104 to one or more of the STAs may be referred to as a downlink (DL) 108, and a communication link that facilitates transmission from one or more of the STAs to the AP 104 may be referred to as an uplink (UL) 110. Alternatively, a downlink 108 may be referred to as a forward link or a forward channel, and an uplink 110 may be referred to as a reverse link or a reverse channel. In some aspects, DL communications may include unicast or multicast traffic indications.

The AP 104 may act as a base station and provide wireless communication coverage in a basic service area (BSA) 102. A BSA (e.g., the BSA 102) is the coverage area of an AP (e.g., the AP 104). The AP 104 along with the STAs associated with the AP 104 and that use the AP 104 for communication may be referred to as a basic service set (BSS). It should be noted that the wireless communication system 100 may not have a central AP (e.g., AP 104), but rather may function as a peer-to-peer (P2P) network between the STAs. Accordingly, the functions of the AP 104 described herein may alternatively be performed by one or more of the STAs.

The AP 104 may transmit on one or more channels (e.g., multiple narrowband channels, each channel including a frequency bandwidth) a beacon signal (or simply a “beacon”), via a communication link such as the downlink 108, to other nodes (STAs) of the wireless communication system 100, which may help the other nodes (STAs) to synchronize their timing with the AP 104, or which may provide other information or functionality. Such beacons may be transmitted periodically. In one aspect, the period between successive transmissions may be referred to as a superframe. Transmission of a beacon may be divided into a number of groups or intervals. In one aspect, the beacon may include, but is not limited to, such information as timestamp information to set a common clock, a peer-to-peer network identifier, a device identifier, capability information, a superframe duration, transmission direction information, reception direction information, a neighbor list, and/or an extended neighbor list, some of which are described in additional detail below. Thus, a beacon may include information that is both common (e.g., shared) amongst several devices, and information specific to a given device.

In some aspects, a STA (e.g., STA 114) may be required to associate with the AP 104 in order to send communications to and/or to receive communications from the AP 104. In one aspect, information for associating is included in a beacon broadcast by the AP 104. To receive such a beacon, the STA 114 may, for example, perform a broad coverage search over a coverage region. A search may also be performed by the STA 114 by sweeping a coverage region in a lighthouse fashion, for example. After receiving the information for associating, either from the beacon or probe response frames, the STA 114 may transmit a reference signal, such as an association probe or request, to the AP 104. In some aspects, the AP 104 may use backhaul services, for example, to communicate with a larger network, such as the Internet or a public switched telephone network (PSTN).

In one aspect, the AP 104 may include one or more components for performing various functions. For example, the AP 104 may include a link configurator 122 to perform procedures associated with link/antenna configuration. In one configuration, the link configurator 122 may be configured to establish a session with a wireless device based on a first set of link parameters and to transmit, to the wireless device, information regarding a second set of link parameters for use by the wireless device for subsequent communication during the session. In another configuration, the link configurator 122 may be configured to establish a session with a wireless device based on a first set of link parameters, to receive, from the wireless device, information regarding a second set of link parameters, and to communicate with the wireless device based on the information regarding the second set of link parameters.

In another aspect, a STA (e.g., any one of STAs 112, 114, 116, or 118) may include one or more components for performing various functions. For example, the STA 114 may include a link configurator 124 to perform procedures associated with link/antenna configuration. In one configuration, the link configurator 124 may be configured to establish a session with a wireless device based on a first set of link parameters and to transmit, to the wireless device, information regarding a second set of link parameters for use by the wireless device for subsequent communication during the session. In another configuration, the link configurator 124 may be configured to establish a session with a wireless device based on a first set of link parameters, to receive, from the wireless device, information regarding a second set of link parameters, and to communicate with the wireless device based on the information regarding the second set of link parameters.

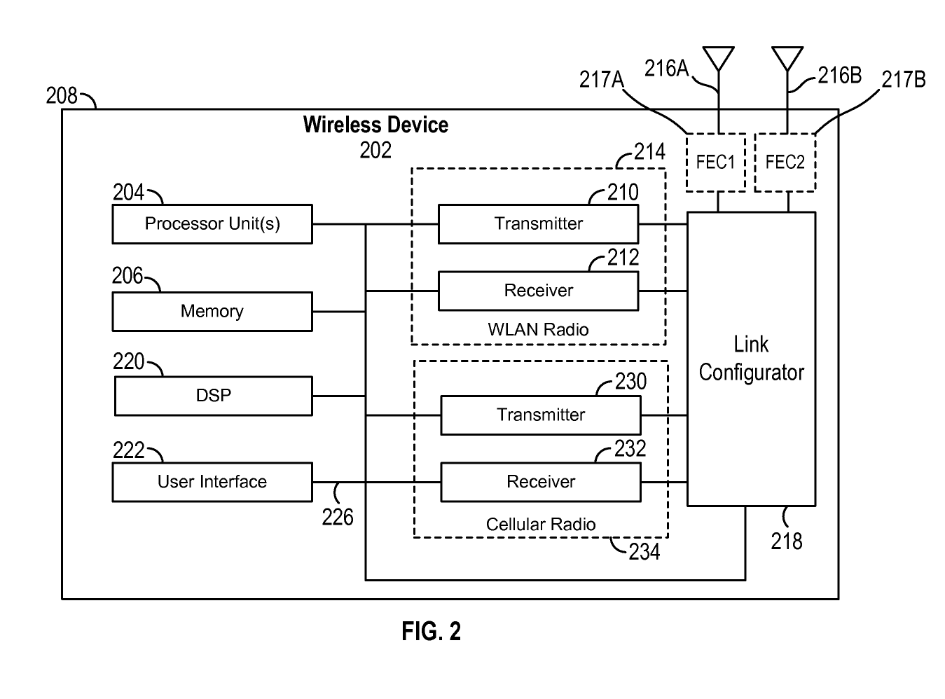

FIG. 2 shows an example functional block diagram of a wireless device 202 that may be employed within the wireless communication system 100 of FIG. 1. The wireless device 202 is an example of a device that may be configured to implement the various methods described herein. For example, the wireless device 202 may comprise the AP 104 or one of the STAs 112, 114, 116, and 118.

The wireless device 202 may include a processor 204 which controls operation of the wireless device 202. The processor 204 may also be referred to as a central processing unit (CPU). Memory 206, which may include both read-only memory (ROM) and random access memory (RAM), may provide instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The processor 204 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), application-specific integrated circuits (ASICs), controllers, state machines, gated logic, discrete hardware components, dedicated hardware finite state machines, or any other suitable entities that can perform calculations or other manipulations of information. In an aspect, the techniques, methods, etc., disclosed herein may be implemented in a modem processor, which may be a baseband processor.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 202 may also include a housing 208, and the wireless device 202 may include multiple radio interfaces (e.g., cellular radio interface, WLAN radio interface, Bluetooth radio interface, etc.). For example, the wireless device 202 may include a WLAN radio having a transmitter 210 and/or a receiver 212 to allow transmission and reception of data between the wireless device 202 and a remote location via WLAN radio techniques. The transmitter 210 and receiver 212 may be combined into a WLAN transceiver 214. As a further example, the wireless device 202 may include a cellular radio having a transmitter 230 and/or a receiver 232 to allow transmission and reception of data between the wireless device 202 and a remote location via cellular radio techniques. The transmitter 230 and receiver 232 may be combined into a cellular transceiver 234. Multiple antennas (e.g., antennas 216A and 216B) may be attached to the housing 208 and electrically coupled to the transceivers 214 and 234. The wireless device 202 may also include other transmitters, multiple receivers, multiple transceivers, and/or multiple antennas.

The wireless device 202 may also include a link configurator 218 that may be used in an effort to determine a link configuration (e.g., an antenna configuration), send/receive information indicating the link configuration, and/or send/receive signals (packets) according to a rate based on the link configuration. In an aspect, the link configurator 218 may map the multiple antennas (e.g., antennas 216A and 216B) to the multiple radio interfaces (e.g., WLAN transceiver 214 and cellular transceiver 234). The wireless device 202 may also include a digital signal processor (DSP) 220 for use in processing signals. The DSP 220 may be configured to generate a signal (packet) for transmission. In some aspects, the packet may include a physical layer convergence protocol (PLCP) protocol data unit (PPDU). The DSP 220 may also be configured to send/receive the generated signals (packets) according to a rate based on the link configuration.

Different radio technologies (e.g., the WLAN transceiver 214 and the cellular transceiver 234) may have similar operating bands. As such, several front-end components (FECs), which may include a power-amplifier, mixer, low-noise amplifier, antenna switch, and/or filters, may also be shared between the respective WLAN transceiver 214 and the cellular transceiver 234. In an aspect, the link configurator 218 may be used to map a first FEC 217A and a second FEC 217B, which may include the antennas 216A and 216B as shown in FIG. 2, to the respective WLAN transceiver 214 or the cellular transceiver 234 by indicating to the WLAN transceiver 214 and/or the cellular transceiver 234 which of the antennas 216A, 216B and/or the first and second FECs 217, 217B to use. The wireless device 202 may include a separate transceiver for peer-to-peer communications (e.g., a Bluetooth radio). Alternatively, the peer-to-peer communications may utilize the WLAN transceiver 214 and/or the cellular transceiver 234.

Further, cellular technologies may support lower bandwidths (e.g., less than 20 megahertz (MHz)) of operation compared to WLAN technologies, which may support operating bandwidths such as 20 MHz, 40 MHz, 80 MHz, and/or 160 MHz. Different front-end/antenna chains on the system may have different bandwidth capabilities. Therefore, in an aspect, the operating mode (modulation and coding scheme, bandwidth, etc.) supported instantaneously by a radio transceiver (e.g., the WLAN transceiver 214 or the cellular transceiver 234) may be constrained by the corresponding FECs 217A, 217B mapped to the radio transceiver.

The wireless device 202 may further comprise a user interface 222 in some aspects. The user interface 222 may comprise a keypad, a microphone, a speaker, and/or a display. The user interface 222 may include any element or component that conveys information to a user of the wireless device 202 and/or receives input from the user.

The various components of the wireless device 202 may be coupled together by a bus system 226. The bus system 226 may include a data bus, for example, as well as a power bus, a control signal bus, and a status signal bus in addition to the data bus. Components of the wireless device 202 may be coupled together or accept or provide inputs to each other using some other mechanism.

Although a number of separate components are illustrated in FIG. 2, one or more of the components may be combined or commonly implemented. For example, the processor 204 may be used to implement not only the functionality described above with respect to the processor 204, but also to implement the functionality described above with respect to the link configurator 218 and/or the DSP 220. Further, each of the components illustrated in FIG. 2 may be implemented using a plurality of separate elements.

In an aspect, higher-order multiple-input multiple-output (MIMO) schemes may be used for WAN (e.g., cellular network such as an LTE network) and WLAN (e.g., Wi-Fi) connectivity. Accordingly, STAs (e.g., cellular handsets or tablet devices or other wireless devices) may implement antenna-sharing (and FEC sharing) to lower bill of materials (BOM) cost on the STAs and meet device form-factor constraints. In antenna-sharing, one or more antennas and/or front-end components may be shared across multiple radios depending on a usage scenario. In an aspect, provided that WAN and WLAN systems may both use higher-order MIMO, it is contemplated that WAN and WLAN radios may have one or more antennas shared between them. Priority may be given to a WAN link in determining the number of antennas available to the WLAN link. In a further aspect, WLAN rate-adaptation algorithms may be implemented based on a transmitter determining a rate, modulation order, and number of space-time streams, etc., to be used based on statistics of past packet error rate (PER) performance.

Intermittent changes in WAN conditions may affect a number of antennas available to a WLAN radio. This affects a MIMO order of a WLAN link maintained between a WLAN AP (e.g., AP 104) and a STA (e.g., any one of STAs 112, 114, 116, or 118) or between two STAs (e.g., the STAs 112, 114). An AP that transmits signals to a STA, but is not aware of the change in the MIMO order of the link, may undesirably transmit a signal to the STA using an MCS that cannot be demodulated by a current STA configuration or does not fully utilize all spatial degrees of freedom.

For example, an AP may determine that a STA receives transmissions via two receive (Rx) antennas, and therefore transmits signals to the STA using an MCS corresponding to two spatial streams. At a later time, unknown to the AP, the number of Rx antennas at the STA may change to one antenna. Accordingly, the AP may undesirably continue to transmit signals (e.g., packets) to the STA using the MCS corresponding to two spatial streams, which cannot be decoded by the STA. Alternatively, unknown to the AP, the number of Rx antennas at the STA may change to a number greater than two (e.g., three or four Rx antennas). Accordingly, the AP continuing to transmit signals to the STA using the MCS corresponding to two spatial streams is inefficient because the AP could transmit more signals (packets) in less time by utilizing the additional spatial streams. Depending on a rate adaptation scheme employed by the AP, the AP may attempt multiple failed transmissions before determining the correct MIMO order for transmitting signals to the STA. By such time, the antenna configuration at the STA may have again changed. Accordingly, because the AP is unaware of the STA's changed antenna configuration, an overall achieved throughput is poor.

In an aspect, a STA may signal a change in capabilities (e.g., change in antenna configuration) via a re-association procedure. During re-association, the STA may transmit a re-association frame in which the STA indicates new capabilities to the AP (or to another STA). However, transmitting the re-association frame may be inefficient for indicating a change in antenna configuration as the re-association procedure may require the frame to be sent at a lowest MCS value. The re-association frame may also contain redundant information that is immaterial to an antenna switch decision. An Rx supported MCS element may be 16 bytes long. Moreover, the re-association procedure results in the AP deleting security keys and forces the re-establishment of a new robust security network association (RSNA) between the STA and the AP. This process may take tens to hundreds of milliseconds and may also result in interruptions to the link and data connectivity, and is therefore not a viable solution when antenna configurations rapidly change.

Accordingly, an aspect of the present disclosure provides for a STA to dynamically inform an AP (or another STA) of a new/modified link configuration while still being associated with the AP (or another STA) (e.g., during a session with the AP or the another STA). In an aspect, the link configuration may include the first and second FECs 217A, 217B. In an aspect, after the STA communicates the new/modified antenna link (and/or band configuration) to the AP, the AP may infer a new rate set supported by the STA based on a previously exchanged (e.g., during association) Rx-supported MCS set. The AP may then generate a signal for the STA based on the new rate set and transmit the signal to the STA. The operation may be extended to a mechanism for re-negotiating link parameters without incurring the drawbacks of the re-association procedure described above.

In an aspect, a STA may instantaneously transmit to an AP (or another STA) information regarding a link configuration (e.g., new/modified antenna configuration). The STA may transmit the information during a session with the AP. The information may include a number of WLAN antennas supported at the STA, a number of Rx-chains supported at the STA, bands of available antennas, supported MCS rates, and channel bandwidths, for example. The AP may adjust an available rate set for transmitting a signal to the STA based on the information regarding the new/modified link configuration sent by the STA. Accordingly, failed transmissions or wasted capacity in WLAN transmissions may be avoided.

In an aspect, the information from the STA may be carried via an 802.11 control frame, management frame, an 802.11 information element of a management frame, or piggybacked on a data frame or a null-frame (e.g., via an antenna control field). The information may include, for example, an instantaneously supported number of antennas, a number of receive chains, a number of space-time streams, a maximum channel bandwidth (e.g., based on a minimum of available WLAN antennas) which may force the system to appropriate WLAN channelization, available bands of operation (e.g., 5 gigahertz (GHz) band, 2.4 GHz band, 900 MHz band, etc.), and/or a time reference (e.g., reference to a network time and/or a timing synchronization function (TSF) at which the new/modified link configuration will be enabled). The information may be transmitted in a packet of a higher priority than other packets sent to the AP.

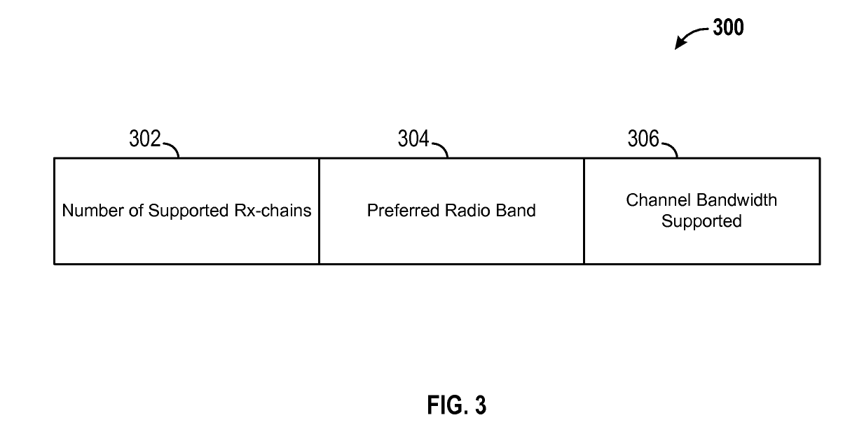

FIG. 3 is a diagram 300 illustrating an example of a signal structure for transmitting information indicating a new/modified link configuration of a wireless device. In FIG. 3, the signal structure includes information pertaining to a number of Rx-chains supported 302 (e.g., represented by a number of bits, such as 3 bits, or an unsigned integer), a preferred radio band 304 (e.g., such as 900 MHz, 2.4 GHz, 5 GHz, represented by a number of bits, such as 2 bits, or an unsigned integer), and a maximum channel bandwidth (BW) supported 306 (e.g., such as 20 MHz, 40 MHz, 80 MHz, or 160 MHz, represented by a number of bits, such as 3 bits, or an unsigned integer), for example.

In an aspect, the value of the preferred radio band 304 may be set to 0, 1, or 2, for example. When the preferred radio band 304 is set to 0, a wireless device may be agnostic as to which radio to use. When the preferred radio band 304 is set to 1, the wireless devices may prefer to use a 900 MHz radio. When the preferred radio band 304 is set to 2, the wireless device may prefer to use a 2.4 GHz radio. When the preferred radio band 304 is set to 3, the wireless device may prefer to use the 5 GHz radio.

In another aspect, the channel BW supported 306 may be a maximum channel BW supported (e.g., 1 MHz, 2 MHz, . . . , 20 MHz, 40 MHz, 80 MHz, 160 MHz, etc.).

The signal structure may include any number of additional fields corresponding to the different types of information described above that may be transmitted in connection with indicating the new/modified link configuration of the STA or the AP.

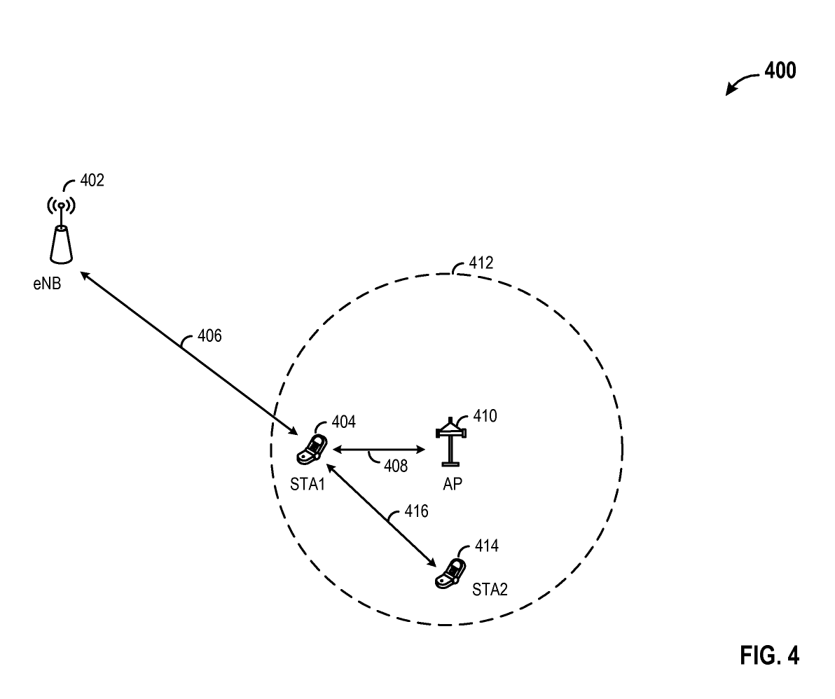

FIG. 4 is a diagram 400 of an exemplary method for signaling a change in link configuration. Referring to FIG. 4, a base station 402 (e.g., an evolved Node B or eNB) may be communicating with a first STA 404 over a WAN link 406. In an aspect, the first STA 404 may have established the WAN link 406 by detecting the base station 402, by transmitting a request to the base station 402 to establish the WAN link 406, and by receiving a response from the base station 402 to establish the WAN link 406. In an aspect, the first STA 404 may have 4 antennas (or any other number of antennas) and may be communicating with the base station 402 using 2 of the 4 antennas. While maintaining the WAN link 406 with the base station 402, the first STA 404 may establish a WLAN link 408 with an AP 410 by associating with the AP 410. The AP 410 may have a BSA 412 and serve the first STA 404, a second STA 414, and any other number of STAs. The first STA 404 may establish the WLAN link 408 with the AP 410 based on a first set of link parameters. In one example, the first set of link parameters may indicate that 2 antennas are available for the WLAN link 408, a maximum channel BW of 40 MHz is supported for the WLAN link 408, and 900 MHz/2.4 GHz bands of operation are available. Based on the first set of link parameters, the AP 410 may transmit data to the first STA 404 using an MCS that may be demodulated using 2 antennas (e.g., transmissions to from the AP 410 to the first STA 404 may have 2 spatial streams).

Subsequently, link conditions of the WAN link 406 may change. In an aspect, the first STA 404 may require additional diversity (e.g., transmit and/or receive diversity) on the WAN link 406, and therefore, may reassign an additional antenna for the WAN link 406. As such, 3 antennas may be used for the WAN link 406 and 1 antenna may be available for the WLAN link 408. In an aspect, based on the change in WAN link conditions, the first STA 404 may determine a second set of link parameters for use by the AP 410 for subsequent communication over the WLAN link 408. In one example, the first STA 404 may determine the second set of link parameters by determining an antenna configuration (e.g., 1 available antenna), a number of supported receive chains (e.g., 1 receive chain), a maximum channel bandwidth supported (e.g., 40 MHz), a preferred channel bandwidth supported (e.g., 20 MHz), a preferred band of operation (e.g., 900 MHz), available bands of operation (e.g., 900 MHz, 2.4 GHz), a maximum number of spatial streams supported (e.g., 1 spatial stream), a highest supported MCS, a maximum AMPDU length, and/or a time at which the second set of link parameters is enabled at the first STA 404. In another aspect, the determination of the second set of link parameters may be based on the available power of the first STA 404 (e.g., if the STA has limited battery power) or on a power profile of the first STA 404 (e.g., minimum power consumption mode, low power mode, or high performance mode).

After determining the second set of link parameters to be used by the AP 410, the first STA 404 may transmit information associated with the second set of link parameters to the AP 410. The information may include any of the information determined with respect to the second set of link parameters. In an aspect, the information may be transmitted in a management frame (e.g., within an information element of the management frame), a data frame (e.g., within a control field of the data frame), a null frame (e.g., within a control field of the null frame), a control frame, in an MPDU of an AMPDU, or in an MSDU of an AMSDU. In another aspect, the first STA 404 may transmit the frame containing the information with a higher priority than other frames transmitted to the AP 410.

Upon receiving the information from the first STA 404, the AP 410 may utilize the information associate with the second set of link parameters for subsequent communication with the first STA 404. That is, the AP 410 may update the antenna configuration associated with the first STA 404. The AP 410 may update one or more of a number of supported receive chains at the first STA 404, a maximum channel bandwidth supported at the first STA 404, a preferred channel bandwidth supported at the first STA 404, a preferred band of operation supported at the first STA 404, available bands of operation at the first STA 404, a maximum number of spatial streams supported at the first STA 404, a highest supported data rate/MCS at the first STA 404, and/or a maximum AMPDU length at the first STA 404.

When the AP 410 has data to transmit to the first STA 404, the AP 410 may generate a signal and transmit the signal to the first STA 404 over the WLAN link 408. The signal may be transmitted according to a transmission mode (e.g., a data rate, an MCS, spatial streams, etc.) based on the received information/second set of link parameters. The first STA 404 may receive the signal transmitted by the AP 410 during the session, and the signal may be received according to the transmission mode determined based on the second set of link parameters. In an aspect, the subsequent transmissions to the first STA 404 using the received information may be based on a time at which the second set of link parameters is enabled at the first STA 404 (e.g., transmit based on the second set of link parameters after the time in which the second set of link parameters is enabled at the first STA 404). Although this example discusses a change in link conditions of the WAN link 406 in which fewer antennas became available for the WLAN link 408, the change in link conditions of the WAN link 406 may result in more antennas becoming available for the WLAN link 408. In this case, the first STA 404 may determine that additional spatial streams, higher bandwidths, and/or a higher MCS may be supported over the WLAN link 408, among other possibilities discussed above.

In another configuration, instead of (or in addition to) establishing the WLAN link 408 with the AP 410, the first STA 404 may establish a peer-to-peer (P2P) link 416 with the second STA 414 based on a third set of link parameters. The first STA 404 may establish the P2P link 416 with the second STA 414 by exchanging peer identification information and by exchanging link information (e.g., supported data rates, security information, etc.). In this configuration, if the first STA 404 maintains the WAN link 406 with the base station 402 and detects a change in link conditions at the WAN link 406, the first STA 404 may determine a fourth set of link parameters to use for subsequent communication with the second STA 414 over the P2P link 416. The determination of the fourth set of link parameters may include the determination of similar types of link parameters as with the determination of the second set of link parameters (e.g., antenna configuration, maximum channel bandwidth, etc.). In an aspect, if the first STA 404 maintains the WAN link 406, the WLAN link 408, and the P2P link 416, the fourth set of link parameters may be determined based on changes in link conditions of the WAN link 406 and/or the WLAN link 408.

In another configuration, instead of a STA changing link parameters, the AP 410 may change link parameters. For example, the AP 410 may be serving the first STA 404, the second STA 414, and/or other STAs on different bands/channels. One or more antennas of the available number of antennas of the AP 410 may be assigned to the first STA 404 on a first band/channel, to the second STA 414 on a second band/channel, and/or to other STAs on other bands/channels. Subsequently, the AP 410 may detect a change in the link conditions in the WLAN link between the AP 410 and the second STA 414, if the second STA 414 requires more throughput (e.g., via a request from the second STA 414). This may require the AP 410 to assign more antennas to the second STA 414 on the second band/channel, which may reduce the number of antennas available for the first STA 404. In another example, if other STAs leave the BSA 412 and certain bands/channels become unused, the AP 410 may have additional antennas/front-end components available for communication. In either scenario, the AP 410 may determine a different set of link parameters to be used with the first STA 404 over the WLAN link 408. The determination of the different set of link parameters may be similar to the steps taken by the first STA 404 for determining updated link parameters (e.g., determine an antenna configuration, etc.). Subsequently, after determining the different set of link parameters to be used with the first STA 404, the AP 410 may transmit information associated with the different set of link parameters to the first STA 404 in a management frame, data frame, null frame, control frame, within an MPDU of an AMPDU, or within an MSDU of an AMSDU. Upon receiving the information, the first STA 404 may utilize the different set of link parameters and transmit data to the AP 410 based on the different set of link parameters (e.g., at a rate based on the different set of link parameters).

In an aspect, the aforementioned examples have given priority to WAN links over WLAN links, and WLAN links over P2P links. In another aspect, a WLAN link may be given priority over WAN links. In this aspect, the first STA 404 may have established the WLAN link 408 with the AP 410 and the WAN link 406 with the base station 402. The first STA 404 may be communicating with the base station 402 based on a fifth set of link parameters. The first STA 404 may determine a change in conditions of the WLAN link 408 (e.g., the first STA 404 may want to increase the number of antennas assigned to the WLAN link 408 or may want to decrease the number of antennas assigned to the WLAN link 408 based on a throughput requirement). The first STA 404 may modify the antenna configuration based on the change in conditions of the WLAN link 408. The first STA 404 may determine a sixth set of link parameters to use over the WAN link 406. The sixth set of link parameters may include the previously discussed link parameters (e.g., antenna configuration, maximum channel bandwidth, etc.). The first STA 404 may transmit information associated with the sixth set of link parameters to the base station 402, and the base station 402 may utilize the sixth set of link parameters for subsequent communication with the first STA 404.

In yet another aspect, the P2P link 416 may have priority over the WLAN link 408 or the WAN link 406. The first STA 404 may modify the respective set of link parameters associated with the WLAN link 408 and/or the WAN link 406 based on a change on conditions of the P2P link 416. As such, any order of priority between WAN links, WLAN links, and P2P links may be available. By enabling the signaling of a change in capabilities, wireless devices may adapt to new configurations in data links with low overhead and fast turnaround without performing re-association. In an aspect, wireless devices may negotiate link parameters with other wireless devices using the configuration signaling mechanisms as discussed without incurring the drawbacks of re-association mechanisms.

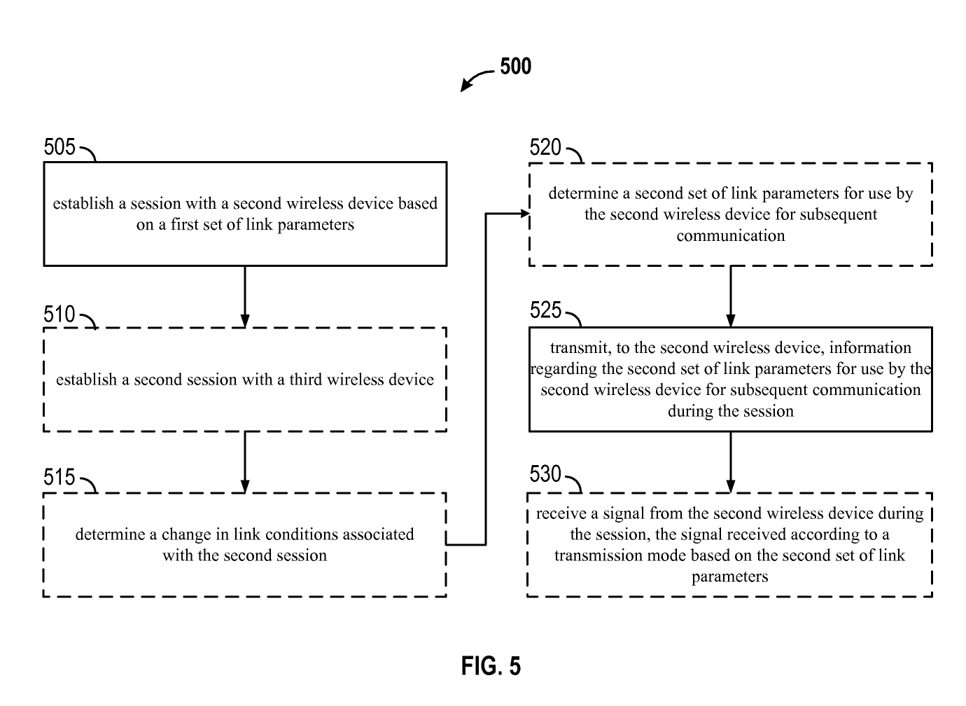

FIG. 5 is a flowchart of an example method 500 of signaling a change in link configuration for wireless communication. The method 500 may be performed using an apparatus (e.g., the wireless device 202 of FIG. 2, for example). The apparatus may be implemented as a STA (e.g., any one of STAs 112, 114, 116, 118, 404) or as an AP (e.g., the AP 104 or the AP 410). Although the method 500 is described below with respect to the elements of wireless device 202 of FIG. 2, other components may be used to implement one or more of the steps described herein.

At block 505, the apparatus, being a first wireless device, may establish a session with a second wireless device based on a first set of link parameters. The session may be a WLAN association. For example, referring to FIG. 4, the apparatus may be the first STA 404. The first STA 404 may establish the WLAN link 408 (e.g., a session) with the AP 410 (e.g., the second wireless device) based on a first set of link parameters (e.g., antenna configuration, etc.).

At block 510, the apparatus may establish a second session with a third wireless device. The second session may be a WAN association. The session and the second session may share antenna resources (e.g., available antennas) and/or front-end components available at the apparatus. For example, referring to FIG. 4, the first STA 404 may establish a WAN link 406 (e.g., the second session) with the base station 402 (e.g., the third wireless device). The WAN link 406 and the WLAN link 408 may share antenna resources and FECs available at the first STA 404.

At block 515, the apparatus may determine a change in link conditions associated with the second session (e.g., more or less throughput is required for the second session or the second session no longer exists). For example, referring to FIG. 4, the first STA 404 may determine that link conditions for the WAN link 406 have changed. In particular, the first STA 404 may determine whether the WAN link 406 requires more antennas. The first STA 404 may determine whether a throughput requirement for the WAN link 406 has changed. The first STA 404 may determine whether the WAN link 406 has been terminated. In an aspect, the WAN link 406 and the WLAN link 408 share a total number of antennas and front-end components available at the STA 404. As such, when one link requires more or less resources, the other link may have correspondingly less or more resources available.

At block 520, the apparatus may determine a second set of link parameters for use by the second wireless device for subsequent communication. The apparatus may detect that a number of antennas available for the session has changed. Accordingly, the apparatus may determine the second set of link parameters by determining a new antenna configuration, a number of a number of supported receive chains, a maximum channel bandwidth supported, a preferred channel bandwidth supported, a preferred band of operation, available bands of operation, a maximum number of spatial streams supported, a highest supported MCS, a maximum AMPDU length, and/or a time at which the second set of link parameters is enabled at the apparatus. For example, referring to FIG. 4, the first STA 404 may determine the second set of link parameters for use by the AP 410 for subsequent communication. In determining the second set of link parameters, the first STA 404 may determine a new antenna/front-end configuration and a highest supported MCS.

At block 525, the apparatus may transmit, to the second wireless device, information regarding a second set of link parameters for use by the second wireless device for subsequent communication during the session. In an aspect, the information may include at least one of an antenna configuration, a number of supported receive chains, a maximum channel bandwidth supported, a preferred channel bandwidth supported, a preferred band of operation, an available band of operation, a maximum number of spatial streams supported, a highest supported data rate/MCS, a maximum AMPDU length, or a time at which the second set of link parameters is enabled. In another aspect, the information may be transmitted in a management frame, an information element of the management frame, a control field of a data frame or of a null frame, a control frame, a data frame, an MPDU within an AMPDU, or an MSDU within an AMSDU. In another aspect, the information may be transmitted to the second wireless device in a packet of a higher priority than other packets transmitted to the second wireless device. For example, referring to FIG. 4, the first STA 404 may transmit, to the AP 410, information regarding the second set of link parameters for use by the AP 410 for subsequent communication with the first STA 404 during the session. The information may include the new antenna configuration and a highest supported MCS. The first STA 404 may transmit the information in a control field of a data frame to the AP 410.

At block 530, the apparatus may receive a signal from the second wireless device during the session, and the signal may be received according to a transmission mode based on the second set of link parameters. For example, referring to FIG. 4, the first STA 404 may receive a signal from the AP 410 during the session, and the signal may be received according to a transmission mode of the AP 410 (e.g., a data rate such as an MCS) based on the second set of link parameters.

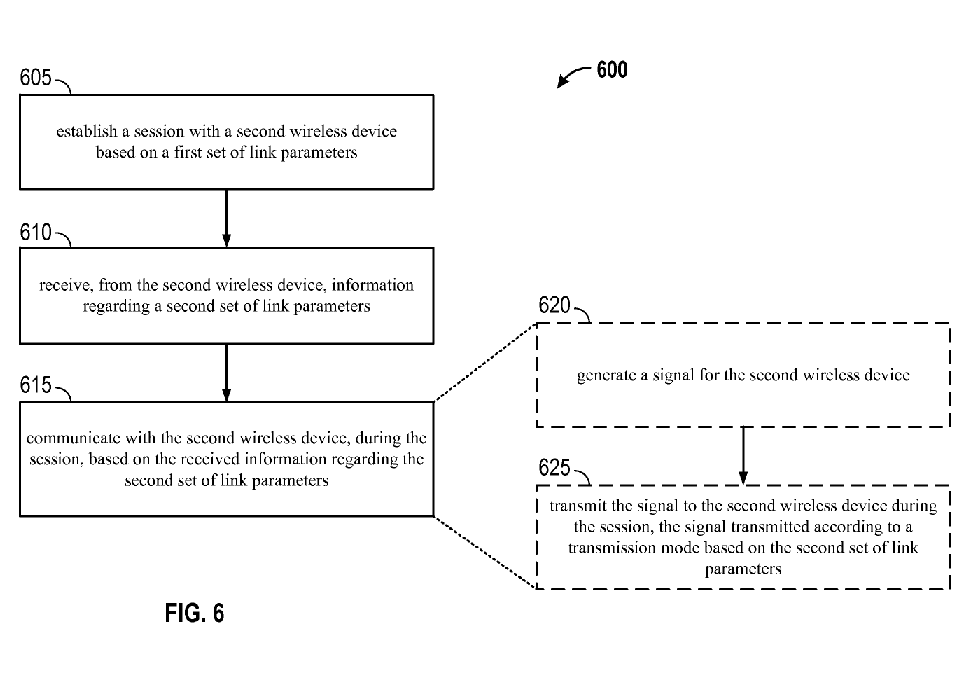

FIG. 6 is a flowchart of an example method 600 receiving an indication of a change in link configuration for wireless communication. The method 600 may be performed using an apparatus (e.g., the wireless device 202 of FIG. 2, for example). The apparatus may be implemented as an AP (e.g., the AP 104 or the AP 410) or as a STA (e.g., the STA 114 or the first STA 404). Although the method 600 is described below with respect to the elements of wireless device 202 of FIG. 2, other components may be used to implement one or more of the steps described herein.

At block 605, the apparatus, being a first wireless device, may establish a session with a second wireless device based on a first set of link parameters. For example, referring to FIG. 4, the AP 410 (e.g., the apparatus or first wireless device) may exchange any number of messages, such as probe request/response messages, authentication request/response messages, and/or association request/response messages to establish a link (e.g., a session/association) with the first STA 404 (e.g., the second wireless device).

At block 610, the apparatus may receive, from the second wireless device, information regarding a second set of link parameters. In an aspect, the information may be received via at least one of a management frame, an information element of the management frame, a control field of a data frame or a null frame, a control frame, a data frame, an MPDU within an AMPDU, or an MSDU within an AMSDU. The information may include at least one of an antenna configuration at the second wireless device, a number of supported receive chains at the second wireless device, a maximum channel bandwidth supported at the second wireless device, a preferred channel bandwidth supported at the second wireless device, a preferred band of operation at the second wireless device, an available band of operation at the second wireless device, a maximum number of spatial streams supported at the second wireless device, a highest supported data rate/MCS at the second wireless device, a maximum AMPDU length, or a time at which the second set of link parameters is enabled. The information may be received from the second wireless device in a packet of a higher priority than other packets received from the second wireless device. For example, referring to FIG. 4, the AP 410 may receive, from the first STA 404, information regarding a second set of link parameters. The information may include an antenna configuration and a maximum MCS and may be received via a data frame.

At block 615, the apparatus may communicate with the second wireless device, during the session, based on the received information regarding the second set of link parameters. For example, referring to FIG. 4, the AP 410 may communicate with the first STA 404 based on the received information regarding the second set of link parameters. The AP 410 may update the antenna configuration associated with the first STA 404 based on the received information and update other configuration information (e.g., highest supported MCS) associated with the first STA 404 based on the received information. In an aspect, the AP 410 may select a link parameter if the second set of link parameters provides a range of parameters for communicating with the first STA 404.

To communicate with the second wireless device, at block 620, the apparatus may generate a signal for the second wireless device. For example, referring to FIG. 4, the AP 410 may generate the signal by determining that the AP 410 has data to transmit and by inserting the data into the payload of one or more packets/frames. The AP 410 may determine a transmission mode (e.g., a data rate, a number of spatial streams, a radio, a channel BW, etc.) for transmitting the data based on the second set of link parameters. Further, at block 625, the apparatus may transmit the signal to the second wireless device during the session, and the signal may be transmitted according to a transmission mode based on the second set of link parameters. In an aspect, the transmission mode may be a data transmission rate (e.g., an MCS rate). In another aspect, the transmission mode may indicate a number of spatial streams to be used, a channel bandwidth, an AMPDU length, and/or other link parameters. In an aspect, the rate may have been previously indicated to the apparatus via a previous exchange of messages (e.g., during session establishment/association) between the apparatus and the second wireless device. For example, referring to FIG. 4, the AP 410 may transmit the signal to the first STA 404 during the session, and the signal may be transmitted according to an MCS based on the second set of link parameters.

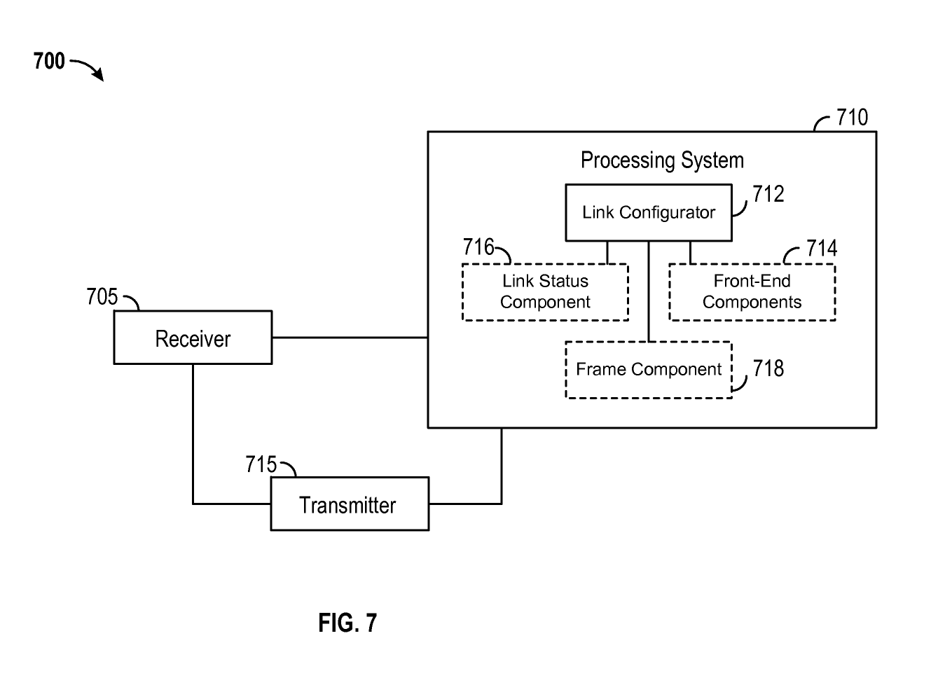

FIG. 7 is a functional block diagram of an example wireless communication device 700 capable of signaling or receiving a change in link configuration. The wireless communication device 700 may include a receiver 705, a processing system 710, and a transmitter 715. The processing system 710 may include a link configurator 712, FECs 714, a link status component 716, and a frame component 718.

In one configuration, the processing system 710 and/or the link configurator 712 may be configured to establish a session with a second wireless device based on a first set of link parameters. The processing system 710, the link configurator 712, and/or the transmitter 715 may be configured to transmit, to the second wireless device, information regarding a second set of link parameters for use by the wireless device for subsequent communication during the session. In an aspect, the processing system 710 and/or the link configurator 712 may be configured to determine the second set of link parameters for use by the second wireless device for subsequent communication. The second set of link parameters may indicate which FECs 714 are available for which session. In an aspect, the second set of link parameters may include at least one of an antenna configuration, a number of supported receive chains, a maximum channel bandwidth supported, a preferred channel bandwidth supported, a preferred band of operation, an available band of operation, a maximum number of spatial streams supported, a highest supported data rate/MCS, a maximum AMPDU length, or a time at which the second set of link parameters is enabled. In another aspect, the established session may be a WLAN association. In another aspect, the processing system 710 and/or the link configurator 712 may be configured to establish a second session with a third wireless device, and the second session may be a WAN association, and the session may be a WLAN association. The session and the second session may share antenna resources or front-end components available at the wireless communication device 700. In one configuration, the processing system 710, the link configurator 712, and/or the link status component 716 may determine a change in link conditions associated with the second session. In this configuration, the second set of link parameters may be determined based on the change in the link conditions associated with the second session. In an aspect, the processing system 710, the link configurator 712, and/or the link status component 716 may determine a change in the link conditions by performing one or more of detecting the second session requires a change in diversity, detecting a throughput requirement associated with the second session has changed, or detecting the second session has terminated. In another aspect, the second wireless device may be an access point or a station. In another aspect, the processing system 710, the link configurator 712, and/or the receiver 705 may be configured to receive a signal from the second wireless device during the session, and the signal may be received according to a transmission mode based on the second set of link parameters. In another aspect, the information may be transmitted via at least one of a management frame, an information element of the management frame, a control field of a data frame or of a null frame, a control frame, a data frame, an MPDU within an AMPDU, or an MSDU within an AMSDU. In this aspect, the frame component 718 may select one of the above options for transmitting the information. In another aspect, the information may include at least one of an antenna configuration, a number of supported receive chains, a maximum channel bandwidth supported, a preferred channel bandwidth supported, a preferred band of operation, an available band of operation, a maximum number of spatial streams supported, a highest supported data rate/MCS, a maximum AMPDU length, or a time at which the second set of link parameters is enabled. In another aspect, the information may be transmitted at a higher MCS than an association frame. In another aspect, the information may be transmitted to the second wireless device in a packet of a higher priority than other packets transmitted to the second wireless device.

In this configuration, the receiver 705, the processing system 710, the link configurator 712, and/or the transmitter 715 may be configured to perform one or more functions discussed above with respect to blocks 505, 510, 515, 520, 525, and 530 of FIG. 5. The receiver 705 may correspond to the receiver 212 or the receiver 232. The processing system 710 may correspond to the processor 204. The transmitter 715 may correspond to the transmitter 210 or the transmitter 230. The link configurator 712 may correspond to the link configurator 218, the link configurator 122, and/or the link configurator 124.

Moreover, means for establishing a session may include the processing system 710 and/or the link configurator 712. Means for establishing a second session may include the processing system 710 and/or the link configurator 712. Means for transmitting information may include the processing system 710, the link configurator 712, the frame component 718, and/or the transmitter 715. Means for determining the second set of link parameters may include the processing system 710 and/or the link configurator 712. Means for determining a change in link conditions may include the processing system 710, the link configurator 712, and/or the link status component 716. Means for receiving a signal may include the processing system 710, the link configurator 712, and/or the receiver 705.

In another configuration, the processing system 710 and/or the link configurator 712 may be configured to establish a session with a second wireless device based on a first set of link parameters. The processing system 710, the link configurator 712, and/or the receiver 705 may be configured to receive, from the second wireless device, information regarding a second set of link parameters. The processing system 710 and/or the link configurator 712 may be configured to communicate with the second wireless device based on the received information regarding the second set of link parameters. In an aspect, the established session may be WLAN association. In another aspect, the processing system 710 and/or the link configurator 712 may be configured to generate a signal for the second wireless device. In this aspect, the processing system 710, the link configurator 712, and/or the transmitter 715 may be configured to transmit the signal to the second wireless device during the session, and the signal may be transmitted according to a transmission mode based on the information regarding the second set of link parameters. In another aspect, the information may be received via at least one of a management frame, an information element of the management frame, a control field of a data frame or a null frame, a control frame, a data frame, an MPDU within an AMPDU, or an MSDU within an AMSDU. In another aspect, the information may include at least one of an antenna configuration at the second wireless device, a number of supported receive chains at the second wireless device, a maximum channel bandwidth supported at the second wireless device, a preferred channel bandwidth supported at the second wireless device, a preferred band of operation at the second wireless device, an available band of operation at the second wireless device, a maximum number of spatial streams supported at the second wireless device, a highest supported data rate/MCS at the second wireless device, or a maximum AMPDU length. In another aspect, the information may include a time at which the second set of link parameters is enabled. In another aspect, the information may be received from the second wireless device in a packet of a higher priority than other packets received from the second wireless device.

In this configuration, the receiver 705, the processing system 710, the link configurator 712, and/or the transmitter 715 may be configured to perform one or more functions discussed above with respect to blocks 605, 610, 615, 620, and 625 of FIG. 6. The receiver 705 may correspond to the receiver 212 or the receiver 232. The processing system 710 may correspond to the processor 204. The transmitter 715 may correspond to the transmitter 210 or the transmitter 230. The link configurator 712 may correspond to the link configurator 218, the link configurator 122, and/or the link configurator 124.

Moreover, means for establishing a session may include the processing system 710 and/or the link configurator 712. Means for receiving information may include the processing system 710, the link configurator 712, and/or the receiver 705. Means for communicate may include receiver 705, the transmitter 715, the processing system 710 and/or the link configurator 712. Means for generating a signal may include the processing system 710 and/or the link configurator 712. Means for transmitting the signal may include the processing system 710, the link configurator 712, and/or the transmitter 715.

As used herein, a phrase referring to “at least one of” a list of items refers to any combination of those items, including single members. As an example, “at least one of: A, B, or C” is intended to cover: A, or B, or C, or any combination thereof (e.g., A-B, A-C, B-C, and A-B-C).

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, components, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that components, modules, and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication by a first wireless device, comprising:
establishing a session with a second wireless device based on a first set of link parameters; and
transmitting, to the second wireless device, information regarding a second set of link parameters for use by the first and second wireless devices for subsequent communication during the session.

2. The method of claim 1, further comprising determining the second set of link parameters for use by the second wireless device for subsequent communication, wherein the second set of link parameters comprises at least one of:
an antenna configuration;
a number of supported receive chains;
a maximum channel bandwidth supported;
a preferred channel bandwidth supported;
a preferred band of operation;
an available band of operation;
a maximum number of spatial streams supported;
a highest supported data rate/modulation and coding scheme (MCS);
a maximum aggregated medium access control protocol data unit (AMPDU) length; or
a time at which the second set of link parameters is enabled.

3. The method of claim 2, further comprising establishing a second session with a third wireless device, the second session being a wide area network (WAN) association, and the session being a wireless local area network (WLAN) association.

4. The method of claim 3, wherein the session and the second session share available antenna resources or available front-end components.

5. The method of claim 3, further comprising determining a change in link conditions associated with the second session, wherein the second set of link parameters is determined based on the change in the link conditions associated with the second session.

6. The method of claim 5, wherein the determining a change in link conditions comprises one or more of:
detecting that the second session requires a change in diversity;
detecting that a throughput requirement associated with the second session has changed; or
detecting that the second session has terminated.

7. The method of claim 1, further comprising:
receiving a signal from the second wireless device during the session, the signal received according to a transmission mode based on the second set of link parameters.

8. The method of claim 1, wherein the information is transmitted via at least one of:
a management frame;
an information element of the management frame;
a control field of a data frame or of a null frame;
a control frame;
a data frame;
a medium access control protocol data unit (MPDU) within an aggregated MPDU (AMPDU); or
a medium access control service data unit (MSDU) within an aggregated MSDU (AMSDU).

9. The method of claim 8, wherein the information is transmitted at a higher modulation and coding scheme (MCS) than an association frame or a re-association frame.

10. The method of claim 1, wherein the information comprises at least one of:
an antenna configuration;
a number of supported receive chains;
a maximum channel bandwidth supported;
a preferred channel bandwidth supported;
a preferred band of operation;
an available band of operation;
a maximum number of spatial streams supported;
a highest supported data rate/modulation and coding scheme (MCS);
a maximum aggregated medium access control protocol data unit (AMPDU) length; or
a time at which the second set of link parameters is enabled.

11. The method of claim 1, wherein the information is transmitted to the second wireless device in a packet of a higher priority than other packets transmitted to the second wireless device.

12. A method of wireless communication by a first wireless device, comprising:
establishing a session with a second wireless device based on a first set of link parameters;
receiving, from the second wireless device, information regarding a second set of link parameters; and
communicating with the second wireless device, during the session, based on the received information regarding the second set of link parameters.

13. The method of claim 12, wherein the established session is a wireless local area network (WLAN) association.

14. The method of claim 12, wherein the communicating further comprises:
generating a signal for the second wireless device; and
transmitting the signal to the second wireless device during the session, the signal transmitted according to a transmission mode based on the received information regarding the second set of link parameters.

15. The method of claim 12, wherein the information is received via at least one of:
a management frame;
an information element of the management frame;
a control field of a data frame or a null frame;
a control frame;
a data frame;
a medium access control protocol data unit (MPDU) within an aggregated MPDU (AMPDU); or
a medium access control service data unit (MSDU) within an aggregated MSDU (AMSDU).

16. The method of claim 12, wherein the information comprises at least one of:
an antenna configuration at the second wireless device;
a number of supported receive chains at the second wireless device;
a maximum channel bandwidth supported at the second wireless device;
a preferred channel bandwidth supported at the second wireless device;
a preferred band of operation at the second wireless device;
an available band of operation at the second wireless device;
a maximum number of spatial streams supported at the second wireless device;
a highest supported data rate/modulation and coding scheme (MCS) at the second wireless device;
a maximum aggregated medium access control protocol data unit (AMPDU) length; or
a time at which the second set of link parameters is enabled.

17. The method of claim 12, wherein the information is received from the second wireless device in a packet of a higher priority than other packets received from the second wireless device.

18. An apparatus for wireless communication, comprising:
a memory; and
at least one processor coupled to the memory and configured to:
establish a session with a wireless device based on a first set of link parameters; and
transmit, to the wireless device, information regarding a second set of link parameters for use by the apparatus and wireless device for subsequent communication during the session.

19. The apparatus of claim 18, wherein the at least one processor is further configured to determine the second set of link parameters for use by the wireless device for subsequent communication, wherein the second set of link parameters comprises at least one of:
an antenna configuration;
a number of supported receive chains;
a maximum channel bandwidth supported;
a preferred channel bandwidth supported;
a preferred band of operation;
an available band of operation;
a maximum number of spatial streams supported;
a highest supported data rate/modulation and coding scheme (MCS);
a maximum aggregated medium access control protocol data unit (AMPDU) length; or
a time at which the second set of link parameters is enabled.

20. The apparatus of claim 19, wherein the at least one processor is further configured to establish a second session with a second wireless device, the second session being a wide area network (WAN) association, and the session being a wireless local area network (WLAN) association.

21. The apparatus of claim 20, wherein the at least one processor is further configured to determine a change in link conditions associated with the second session, wherein the second set of link parameters is determined based on the change in the link conditions associated with the second session.

22. The apparatus of claim 18, wherein the at least one processor is further configured to receive a signal from the wireless device during the session, the signal received according to a transmission mode based on the second set of link parameters.

23. The apparatus of claim 18, wherein the information is transmitted via at least one of:
a management frame;
an information element of the management frame;
a control field of a data frame or a null frame;
a control frame;
a data frame;
a medium access control protocol data unit (MPDU) within an aggregated MPDU (AMPDU); or
a medium access control service data unit (MSDU) within an aggregated MSDU (AMSDU).

24. The apparatus of claim 18, wherein the information is transmitted to the wireless device in a packet of a higher priority than other packets transmitted to the wireless device.

25. An apparatus for wireless communication, comprising:
a memory; and
at least one processor coupled to the memory and configured to:
establish a session with a wireless device based on a first set of link parameters;
receive, from the wireless device, information regarding a second set of link parameters; and
communicate with the wireless device, during the session, based on the received information regarding the second set of link parameters.

26. The apparatus of claim 25, wherein the established session is a wireless local area network (WLAN) association.

27. The apparatus of claim 25, wherein the at least one processor is configured to communicate with the wireless device by:
generating a signal for the wireless device; and
transmitting the signal to the wireless device during the session, the signal transmitted according to a transmission mode based on the information regarding the second set of link parameters.

28. The apparatus of claim 25, wherein the information is received via at least one of:
a management frame;
an information element of the management frame;
a control field of a data frame or a null frame;
a control frame; or
a data frame;
a medium access control protocol data unit (MPDU) within an aggregated MPDU (AMPDU); or
a medium access control service data unit (MSDU) within an aggregated MSDU (AMSDU).

29. The apparatus of claim 25, wherein the information comprises at least one of:
an antenna configuration at the wireless device;
a number of supported receive chains at the wireless device;
a maximum channel bandwidth supported at the wireless device;
a preferred channel bandwidth supported at the wireless device;
a preferred band of operation at the wireless device;
an available band of operation at the wireless device;
a maximum number of spatial streams supported at the wireless device;
a highest supported data rate/modulation and coding scheme (MCS) at the wireless device;
a maximum aggregated medium access control protocol data unit (AMPDU) length; or
a time at which the second set of link parameters is enabled.

30. The apparatus of claim 25, wherein the information is received from the wireless device in a packet of a higher priority than other packets received from the wireless device.
